(19) United States
(12) Patent Application Publication
(10) Pub. No.: US 2002/0077945 A1
(43) Pub. Date: Jun. 20, 2002

(54) Multiple audit trails in workflow-management-systems

(75) Inventors: Frank Leymann, Aidlingen (DE); Dieter Roller, Schoenaich (DE)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/003,124

(22) Filed: Nov. 15, 2001

(30) Foreign Application Priority Data
Nov. 23, 2000 (EP) 00125607.2

(51) Int. Cl. G06F 17/60

(52) U.S. Cl. 705/35

(57) ABSTRACT

Proposed is a mechanism for writing audit trail records in a Workflow-Management-System (WFMS) which comprises the steps of:

Assigning a multitude of audits trails as potential targets for audit trail records to said WFMS, and

Assigning an audit trail distribution strategy to said WFMS, comprising a specification which of said potential targets to be used for writing an audit trail record, and

Dynamically analyzing for a current audit trail record said distribution strategy and determining a current target from said multitude of audit trails, and

Writing said current audit trail record to said current target.

By the proposed mechanism the contention on the audit trail is reduced. Therefore by implementing the present invention the response time of requests, processing time of process instances, and the throughput of the WFMS is improved.

### BACKGROUND OF THE INVENTION

1. Field of the Invention

The present invention relates to Workflow-Management-Systems. More particularly the present invention relates to a method and system for writing audit trails in Workflow-Management-Systems.

2. Description and Disadvantages of Prior Art

A new area of technology with increasing importance is the domain of Workflow-Management-Systems (WFMS). WFMS support the modeling and execution of business processes. Business processes executed within a WFMS environment control which piece of work of a network of pieces of work will be performed by whom and which resources are exploited for this work. The individual pieces of work might be distributed across a multitude of different computer systems connected by some type of network. A thorough representation of WFMS technology is given by Frank Leymann and Dieter Roller, Production Workflow: Concepts and Techniques, Prentice-Hall, Upper Saddle River, N.J., 2000.

The product “IBM MQSeries Workflow” represents such a typical modern, sophisticated, and powerful workflow management system. It supports the modeling of business processes as a network of activities. This network of activities, the process model, is constructed as a directed, acyclic, weighted, colored graph. The nodes of the graph represent the activities which are performed. The edges of the graph, the control connectors, describe the potential sequence of execution of the activities. Definition of the process graph is via the IBM MQSeries Flow Definition Language (FDL) or the built-in graphical editor.

A particular instance of said process graph is called a process model, which is a template from which process instances are created. The actual execution of a particular process instance depends on data (fields) associated with the process instance, the context. The schema of the context, such as the names and types of the appropriate fields is described on the process model level; the actual data of the context (called shortly context), that means the values assumed by the different fields, is either already defined at the process model level as constants (default values) is created when a particular process instance is being carried out. Thus the context causes for different process instances to have different execution histories.

The runtime component of the WFMS, called the navigator or execution server, creates process instances from these process models, interprets these process instances, and distributes the execution of appropriate activities to the right person at the right place, for example by assigning tasks to a work list maintained for the respective person.

WFMSs in general support the writing of an audit trail, a collection of audit trail records, to an audit trail store. An audit trail record contains all relevant information about a particular event in the life or a process or activity, such as the start of a process or the completion of an activity. Thus the audit trail contains the more or less the fine-grained execution history of a particular process instance.

The audit trail can be used for many purposes: for example, it may be required for legal reasons to keep the complete execution history of each executed business, or it can be used to perform an analysis of the business processes to determine bottlenecks or possible improvements.

The properties of the audit trail, such as the location of storage and underlying persistence mechanism, can normally be specified by the user. The persistence, for example, could be provided by as a relational database managed by a relational database management system, a queue managed by a message qeueing system, or a message sent to an e-mail system. Not all WFMSs support the specification of the properties of the audit trail; MQSeries Workflow, for example, only supports a particular table in a relational database as the location and persistence mechanism for the audit trail.

The amount of audit trail records that are written is either fixed or can be specified by the process modeler on the model level, that means on the level of the process model or on the level of the activity within the process model. In MQSeries Workflow this is specified via the AUDIT keyword. Parameters for the AUDIT keyword are NO, CONDENSED, and FULL. NO indicates that no audit trail is written at all, CONDENSED that only important events are written to the audit trail, and FULL that all events are written to the audit trail.

Typically, WFMSs support inheritance for audit trail specifications. If no specification is available for a dependent object, this object inherits the specification from it's parent. If no audit specification is provided for an activity, for example, the audit specifications associated with the encompassing process model are used; if no audit specification is provided for a process model, the global audit specifications of the workflow management system are used.

A most important problem associated with this state of the art technology is a significant performance degradation of the WFMS when carrying out process instances of a process model in parallel and writing audit trail records to a common (shared) audit trail. This generates contention situations for said audit trail. Process instances, which actually would be ready to proceed independently from one another, have to wait for getting access to the audit trail store. The overall performance of WFMS suffers degradation.

Another most important problem with the state of the art technology is that the audit trail grows rather quickly in size, which causes performance to suffer as the insertion of new audit trail records may become more expensive.

Another problem with the state of the art technology is that the fast growth of the audit trail makes maintenance not only cumbersome, but also more expensive as the removal of old audit trail records from the audit trail becomes more expensive.

### OBJECTIVE OF THE INVENTION

The invention is based on the objective to improve or to optimize the performance of a WFMS, in particular to improve or to optimize the audit trail processing of a WFMS.

### SUMMARY AND ADVANTAGES OF THE INVENTION

The objectives of the invention are solved by the independent claims. Further advantageous arrangements and embodiments of the invention are set forth in the respective subclaims.

The concept underlying the invention is to have multiple audit trails and dynamically select either the most appropriate audit trail or a user-specified audit trail. The objective is solved by evaluation of the appropriate definitions, either given for a particular process model or specified globally for the workflow management system level, particularly comprising the following steps:

Assigning a multitude of audits trails as potential targets for audit trail records to said WFMS, and

Assigning an audit trail distribution strategy to said WFMS, comprising a specification which of said potential targets to be used for writing an audit trail record, and

Dynamically analyzing for a current audit trail record said distribution strategy and determining a current target from said multitude of audit trails, and

Writing said current audit trail record to said current target.

The current invention contrasts to the prior art approaches, where WFMSs were only supporting a common (shared) audit trail for all process instances and activity instances. By supporting multiple audit trails and dynamically selecting the appropriate audit trail based on definitions on the workflow management system level or process model and activity within process model level, distinct audit trails are written.

The most important advantage of the current invention is that the contention on the audit trail is reduced as no longer are all audit trail records written to the same audit trail. This allows carrying out of process instances in parallel without the need of waiting for the audit trail to become available.

Another important aspect is that the writing and removal of audit trail records in audit trails is much more efficient.

By implementing the present invention, the response time of requests, the processing of process instances, and the throughput of the WFMS is improved.

### BRIEF DESCRIPTION OF THE DRAWINGS

FIG. 1 shows the structure of a workflow management system that supports parallel processing for carrying out process instances and supports multiple audit trails according to a first embodiment of the present invention,

FIG. 2 shows an example of the definition of an audit trail that is handled as a table managed by a relational database management system according to a second embodiment of the present invention,

FIG. 3 shows an example of the definition of the default audit trail to be used by the workflow management if not another audit trail specification is provided, according to a third embodiment of the present invention,

FIG. 4 shows an example of a server controlled selection of the appropriate audit trail according to a fourth embodiment of the present invention,

FIG. 5 shows an example of a process model controlled selection of the appropriate audit trail according to a fifth embodiment of the present invention,

FIG. 6 shows an example of a process model, context based, controlled selection of the audit trail according to a sixth embodiment of the present invention,

FIG. 7 shows an example of an activity controlled selection of the audit trail according to a seventh embodiment of the present invention,

FIG. 8 shows an example of an activity, context based, controlled selection of the audit trail according to an eight embodiment of the present invention.

### DESCRIPTION OF THE PREFERRED EMBODIMENT

The current invention is illustrated based on IBM's MQSeries Workflow workflow management system. Of course any other WFMS could be used instead. Furthermore the current teaching applies also to any other type of system which offers WFMS functionalities not as a separate WFMS but within some other type of system.

Introduction

The following is a short outline on the basic concepts of a workflow management system based on IBM's MQSeries Workflow WFMS as far as it is of importance for the current invention.

From an enterprise point of view the management of business processes is becoming increasingly important. Business processes or process for short control which piece of work will be performed by whom and which resources are exploited for this work, i.e. a business process describes how an enterprise will achieve its business goals. A WFMS may support both, the modeling of business processes and their execution. Modeling of a business process as a syntactical unit in a way that is directly supported by a software system is extremely desirable. Moreover, the software system can also work as an interpreter basically getting as input such a model. The model, called a process model or workflow model, can then be instantiated and the individual sequence of work steps depending on the context of the instantiation of the model can be determined. Such a model of a business process can be perceived as a template for a class of similar processes performed within an enterprise; it is a schema describing all possible execution variants of a particular kind of business process. An instance of such a model and its interpretation represents an individual process, i.e. a concrete, context dependent execution of a variant prescribed by the model. A WFMS facilitates the management of business processes. It provides a means to describe models of business processes (build time) and it drives business processes based on an associated model (run time). The meta model of IBM's WFMS MQSeries Workflow, i.e. the syntactical elements provided for describing business process models, and the meaning and interpretation of these syntactical elements, is described next.

A process model is a complete representation of a process, comprising a process diagram and the settings that define the logic behind the components of the diagram. Important components of a MQSeries Workflow process model are:

Processes

Activities

Blocks

Control Flows

Connectors

Data Containers

Data Structures

Programs

Staff

Not all of these elements will be described below.

Activities are the fundamental elements of the meta model. An activity represents a business action that is from a certain perspective a semantic entity of its own.

A MQSeries Workflow process model consists of the following types of activities:

Program activity: Has a program assigned to perform it. The program is invoked when the activity is started. In a fully automated workflow, the program performs the activity without human intervention. Otherwise, the user must start the activity by selecting it from a runtime work list.

Process activity: Has a (sub-) process assigned to perform it. The process is invoked when the activity is started. A process activity represents a way to reuse a set of activities that are common to different processes.

The flow of control, i.e. the control flow through a running process determines the sequence in which activities are executed. The MQSeries Workflow workflow manager navigates a path through the process.

The results that are in general produced by the work represented by an activity is put into an output container, which is associated with each activity. Since an activity will in general require to access output containers of other activities, each activity is associated in addition with an input container too.

Connectors link activities in a process model. Using connectors, one defines the sequence of activities and the transmission of data between activities. Since activities might not be executed arbitrarily they are bound together via control connectors. A control connector might be perceived as a directed edge between two activities; the activity at the connector's end point cannot start before the activity at the start point of the connector has finished (successfully). Control connectors model thus the potential flow of control within a business process model. Data connectors specify the flow of data in a workflow model. A data connector originates from an activity or a block, and has an activity or a block as its target. One can specify that output data is to go to one target or to multiple targets. A target can have more than one incoming data connector.

A process definition includes modeling of activities, control connectors between the activities, input/output containers, and data connectors. A process is represented as a directed acyclic graph with the activities as nodes and the control/data connectors as the edges of the graph. The graph is manipulated via a built-in graphic editor. The data containers are specified as named data structures. These data structures themselves are specified via the DataStructureDefinition facility. Program activities are implemented through programs. The programs are registered via the Program Definition facility. Blocks contain the same constructs as processes, such as activities, control connectors etc. Process activities are implemented as processes. These subprocesses are defined separately as regular, named processes with all its usual properties. Process activities offer great flexibility for process definition. It not only allows the construction of a process through permanent refinement of activities into program and process activities (top-down), but also the building of a process out of a set of existing processes (bottom-up).

All programs which implement program activities are defined via the Program Registration Facility. Registered for each program is the name of the program, its location, and the invocation string. The invocation string consists of the program name and the command string passed to the program.

Multiple Audit Trails

In the prior art, WFMs use only one common (shared) audit trail for recording audit trail information; some of them allow the user to specify the properties of the audit trail.

A first most important observation is, that the prior art approach creates contentions on the audit trail if the workflow management system exploits parallel processing of different process instances to speed up the execution of business processes. In this case, the parallel executing process instances compete for the (shared) audit trail, which decreases the parallelism as all process instances need to get access to the audit trail. The present invention proposes to have multiple audit trails which provide for less overall contention by limiting any remaining contention to the individual audit trails.

A second important observation for the prior art approach can be made with respect to the size of the audit trail. The larger the audit trail gets, the more time and resources it takes to insert new audit trail records and to remove audit trail records. By having multiple audit trails, the size of the individual audit trails is much smaller, making insertion and removal of audit trail records much more efficient.

As already pointed out, the present invention suggests having multiple audit trails. A general approach to solving the above mentioned problems would suggest an audit trail distribution strategy assigned to the WFMS. The distribution strategy is based upon a specification of which said potential audit trails are actually used for writing an audit trail record. The distribution strategy is then dynamically analyzed during runtime for determining the concrete audit trail to be used for writing a current audit trail record.

It further suggests having two mechanism for selecting which audit trail to use in a particular situation: the server-controlled audit trail selection mode and the model-controlled audit trail selection mode. In the server-controlled audit trail selection mode, the workflow management system automatically assigns a particular audit trail to one or more server instances. In the model-controlled audit trail selection mode, the process modeler specifies for each process model or even each activity within a process model, which particular audit trail should be used for audit trail records generated.

In the following example the support of multiple audit trails either controlled via server specification or by model specifications is illustrated.

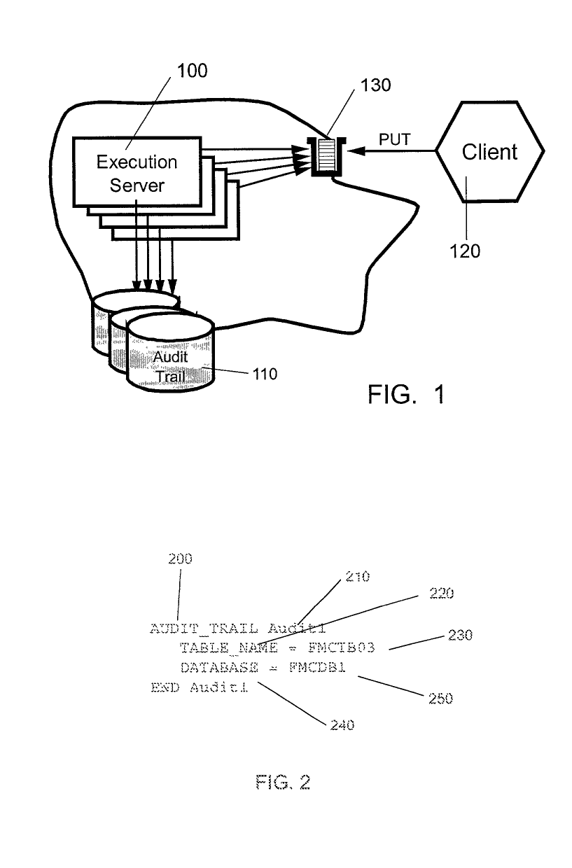

FIG. 1 shows a particular system structure of a workflow management system that provides for the parallel processing of process instances. It is set up as a message-based application server, that consists of a set of execution server instances (execution servers, for short) (100) running in parallel; all of them processing process instances. New requests for the workflow management system are provided by clients (120) putting messages into a queue (130) from which all execution servers are reading. The client (120) can also be another component of the workflow management system or even an execution server. The audit trails generally reside in some store (110) either persistent or non-persistent. It should be noted that the system structure shown in FIG. 1 serves only as an example; any other system structure that provides for parallelism can be exploited via the present invention.

FIG. 2 shows the definition of the properties for an audit trail. It should be noted that in all figures of this description the Flow Definition Language (FDL) of MQSeries Workflow is used; any other language, textual as well as graphical, could be used instead. The keyword AUDIT_TRAIL (200) starts the definition for an audit trail; the name of the audit trail is Audit1 (210). The keyword TABLE_NAME (220) indicates that the audit trail is managed as a table in a relational database management system; the name of the table is FMCTB01. The keyword DATABASE (240) indicates the database the table is in; the database name is FMCDBL (250). It should be noted that it is not required that the audit trails are defined as a separate entity; any other method will do it.

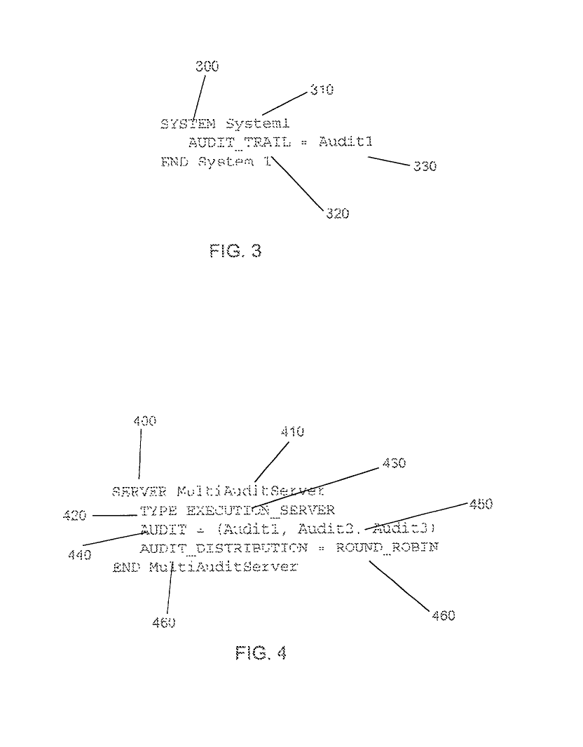

FIG. 3 shows the definition of the default audit trail; the specified audit trail will be used when no specific audit trail is specified in an AUDIT statement associated with a process model or an activity in a process model. It should be noted, that the capability of being able to define a default audit trail is not necessary for the present invention to work; it's provided here for completeness, as a workflow management system would need to provide this for ease-of-use. The keyword SYSTEM (300) is used to define the properties of an instance of a workflow management system; the name of the instance is System1 (310). The keyword AUDIT_TRAIL (320) defines the default audit trail; the name of the audit trail is Audit1 (330). It should also be noted that this definition is only required for model-controlled audit trail selection as a method to refer from definitions within the process model to this definition by the audit trail name Audit1.

Server-Controlled Audit Trail Selection

In the server-controlled audit trail selection mode, each of the defined audit trails is assigned to zero, one, or more instances of the execution server (as shown in FIG. 1). The method of assigning of an audit trail to a server instance can be defined by the user.

FIG. 4 shows an example of the definition of the properties of the execution server and in particular the definition of the audit trails to be used in server-controlled audit trail selection. The keyword SERVER (400) starts the definition of a server, in this case named MultiAuditServer (410). The keyword TYPE (420) starts the definition of the type of server, the parameter EXECUTION_SERVER (430) defines this server as an execution server; that means the server that performs navigation and execution of process instances. The keyword AUDIT (440) is used to define the list of audit trails, that should be used in server-controlled audit trail selection, namely Audit1, Audit2, and Audit 3 (450). The keyword AUDIT_DISTRIBUTION (460) defines the method of assigning audit trails to execution server instances. The specification of ROUND_ROBIN (460) indicates that the assignment is round robin. If, for example, the execution server runs four instances ES1, ES2, ES3, and ES4. Then Audit1 would be assigned to ES1 and ES4, Audit2 to ES2, and Audit3 to ES3. Of course other distribution strategies are possible instead of round-robin.

A major advantage of the server-controlled audit trail selection is the same utilization of all audit trails. The major disadvantage of this approach is the scattering of audit trail records of the same process instance over all audit trails making the analysis of the audit trail more cumbersome.

Model-Controlled Audit Trail Selection

In the model-controlled audit trail section mode, the process modeler specifies for process models or even activities within a process model the audit trail that should be used for writing audit trail records.

FIG. 5 shows an example of the definition of an audit trail on the process level. The keyword PROCESS (500) starts the definition of a process model LoanProcess (510). The keyword AUDIT (520) which defines the amount of audit trail information written as known from prior art (the specification of CONDENSED (530) request a condensed audit trail) is augmented according to the present invention with an AUDIT_TRAIL keyword (540). The AUDIT_TRAIL keyword indicates which audit trail should be selected for writing audit trail records; in the example, audit trail records should be written to the audit trail Audit1 (540).

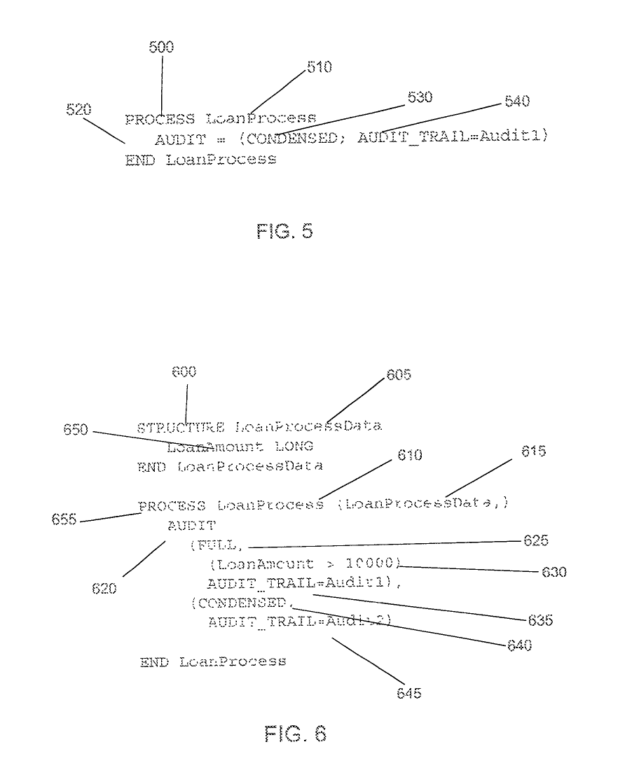

FIG. 6 shows how the audit definition can also contain context based selection criteria based on the runtime evaluation of an evaluatable expression. The STRUCTURE (600) keyword defines a data structure LoanProcessData (605) which consists of a field LoanAmount (650). The actual definition of the process LoanProcess (610) starts with the keyword PROCESS (655); the data structure LoanProcessData (615) is used as input container.

The AUDIT keyword (620) is associated with two audit trail sub-specifications: one with a context based selection criteria (630), a corresponding audit volume parameter FULL (625), and an associated audit trail of Audit1 (635); the other with just an audit volume parameter CONDENSED (640) and an associated audit trail of Audit2 (645). According to this definition of the process, a full audit trail is written to audit trail Audit1 for loan processes with a loan amount exceeding $10.000; a condensed audit trail is written to audit trail Audit2 for all other business process instances.

In FIG. 7 a further embodiment is shown, enhancing the example of the embodiment of FIG. 5, where model-based audit trail selection is applied to the activity level. For this purpose an audit trail specification, identified via the AUDIT keyword (725), is added for the activity CollectCreditInformation (730) which is identified via the PROGRAM_ACTIVITY keyword (750). The audit trail volume parameter FULL (735) indicates that a full audit trail should be written and the AUDIT_TRAIL=Audit2 (740) specification indicates that the appropriate audit trail records should be written to the audit trail Audit2. As a consequence of the audit definitions, a condensed audit trail is written to audit trail Audit1 for all activities except the CollectCreditInformation activity for which a full audit trail is written to the audit trail Audit2.

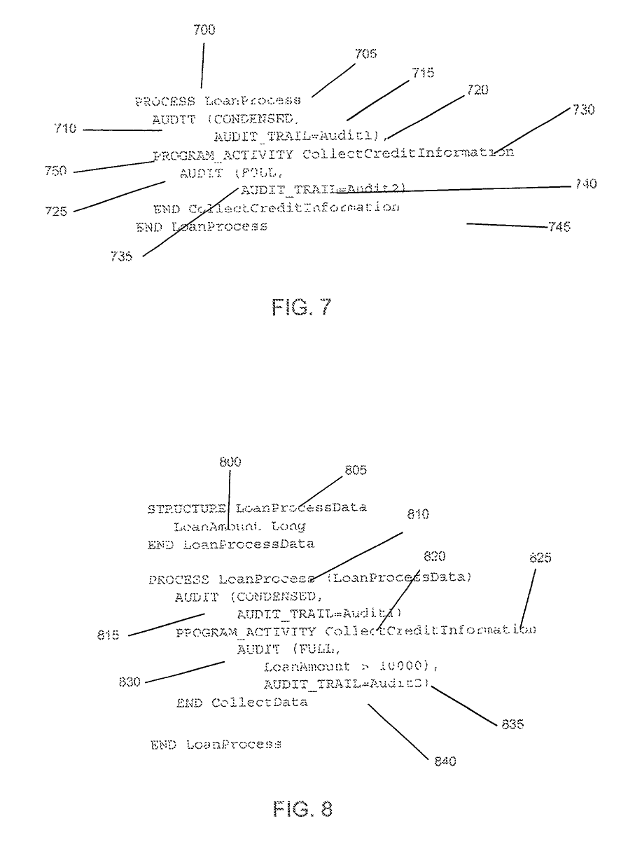

FIG. 8 enhances the example given in FIG. 7 by adding a context based selection criteria (835) that causes the full audit trail for the CollectCreditInformation activity only to be written when the loan amount exceeds $10.000 (based on the runtime evaluation of an evaluatable expression).

The model-controlled audit trail selection has the major advantage that the audit trail information for business processes can be kept together in one audit trail (unless explicitly specified by the process modeler) making the analysis of the audit trail simple and easy manageable. On the other hand this may possibly result in an unequal utilization of the various audit trails depending on the execution frequency of individual process models or program activities.

The present invention can be realized in hardware, software, or a combination of hardware and software. A WFMS according to the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

1. A computerized method for writing audit trails in a Workflow-Management-System (WFMS), said method being executable by said WFMS on at least one computer system, said method comprising the steps of:
assigning a multitude of audits trails as potential targets for one or more audit trail records to said WFMS, and
assigning an audit trail distribution strategy to said WFMS,
comprising a specification which of said potential targets to be used for writing said audit trail record, and
dynamically analyzing for a current audit trail record said distribution strategy and determining a current target from said multitude of audit trails, and
writing said current audit trail record to said current target.

2. Method according to claim 1,
wherein said step of assigning said distribution strategy comprises a SYSTEM-specification associating each WFMS instance of a multitude of WFMS instances with an audit trail of said multitude of audits trails.

3. Method according to claim 1,
wherein associating said each WFMS instance is accomplished according to a round-robin scheme with said multitude of audit trails.

4. Method according to claim 1,
wherein said step of assigning said distribution strategy comprises a PROCESS-specification in a process model associating said process model with an audit trail of said multitude of audits trails.

5. Method according to claim 1,
wherein said step of assigning said distribution strategy comprises an ACTIVITY-specification in a process model associating an activity comprised by said process model with an audit trail of said multitude of audits trails.

6. Method according to claim 5,
wherein said ACTIVITY-specification overrides said PROCESS-specification.

7. Method according to claims 6,
wherein said specification comprising an evaluatable expression, and wherein said step of dynamically analyzing comprising evaluating said evaluatable expression using a variable value not comprised in said process model but being comprised in a context of a process instance of said process model to determine said current target.

8. Method according to claim 7,
wherein said specification comprises a definition of a level of details to be comprised by an audit trail record.

9. A Workflow-Management-System (WFMS) executable on at least one computer system, the WFMS comprising means adapted for carrying out the steps of the method according to anyone of the preceding claims 1 to 8.

10. A data processing program for execution in a data processing system comprising software code portions for performing a method according to any of claims 1 to 8 when said program is run on said computer.

11. A computer program product stored on a computer usable medium, comprising computer readable program means for causing a computer to perform a method according to any claims 1 to 11 when said program is run on said computer.
